(19) United States
(12) Patent Application Publication
(10) Pub. No.: US 2014/0244606 A1
(43) Pub. Date: Aug. 28, 2014

(54) METHOD, APPARATUS AND SYSTEM FOR STORING, READING THE DIRECTORY INDEX

(71) Applicant: Tencent Technology (Shenzhen) Company Limited, Shenzhen City (CN)

(72) Inventor: Jibing LOU, Shenzhen City (CN)

(73) Assignee: Tencent Technology (Shenzhen) Company Limited, Shenzhen City (CN)

(21) Appl. No.: 14/262,684

(22) Filed: Apr. 25, 2014

Related U.S. Application Data
(63) Continuation of application No. PCT/CN2013/087582, filed on Nov. 21, 2013.

(30) Foreign Application Priority Data
Jan. 18, 2013 (CN) 201310019873.2

(51) Int. Cl. G06F 17/30

(52) U.S. Cl. CPC G06F 17/30336
USPC 707/696

(57) ABSTRACT

A method, apparatus and system for storing and reading the directory index and belongs to the field of computer technology is provided. The method includes: configuring all directories in the directory index with identifiers respectively; according to each directory identifier, splitting the directory index so as to obtain the directory split item corresponding to each directory identifier, wherein each directory split item and its corresponding directory identifier are stored as a record item, and each directory split item comprises at least corresponding sub-directory identifier and corresponding file storage address. By the configuration of the disclosure, the granularity of the directory index is refined, and access performance for the directory index is improved.

### CROSS-REFERENCE TO RELATED APPLICATIONS

This application is a U.S. continuation application of International Application PCT/CN2013/087582, with an international filing date of Nov. 21, 2013, which claims the priority benefit of Chinese Patent Application No. 201310019873.2 filed on Jan. 18, 2013, the contents of which are both incorporated herein by reference in their entireties for all intended purposes.

### FIELD OF THE INVENTION

The invention relates to the field of computer technology, in particular to a method, apparatus and system for storing, reading the directory index.

### BACKGROUND

As computer technology continues to develop, the directory index as an important component of file system provides users with visual and understandable view of the file system, so as to solve or reduce the semantic isolation in the data storage between people and computers. The storing manner of the directory index directly determines the way of accessing the directory index and efficiency thereof. In order to quickly and efficiently access the directory index, how to store the directory index has become a key issue.

In the prior art, one way is block-based device index storage, that is, the system directory index is stored on the disk directly. Such as EXT3 (Third extended file system, the third extended file system), it divides logical disk into fixed-size logical disk blocks (simply referred to as block), each disk block in the file system has a globally unique block number; a certain number of blocks are combined into logical disk group (simply referred to as group); a disk group is divided, according to function, into the following sections: data block bitmap corresponding to the block number of the set of data block and being for allocation and recovery of the disk block in the group; index node bitmap corresponding to the block number of the set of index block and being for allocation and recovery of the index node; index table corresponding to the group index node group and being for saving the directory or file index data block group; data block group being used to store the actual directory or file specific data. Each index node is used to record information about a file or directory. When indexing directory, the node saves data block number where the directory data is, and the data block record all the files and subdirectories index information of the directory; Another way is directory index storage based on a database, its files and directories index data are stored in the database, parent-child relationship between directories and files is associated through each table items, tree view can be achieved at the user interface layer. Directory index is stored in the database server, while the actual file data is stored in the I/O (Input/Output, input and output ports) server.

In the process of carrying out the invention, the inventor finds that the prior art at least has the following problems:

In the first way, since the directory index and the actual file data are stored in the same medium, when there is massive file data, storage space where the directories index itself occupied is as many as dozens of T (Tera), and these huge numbers of directory index is difficult to be stored on the local disk, the massive demand for distributed storage cannot be meet; in the second way, because the directory index storage is based on the database, in the subsequent batch operation for the directory index, the access number for directory index will be multiplied, resulting in poor access performance.

### SUMMARY OF THE INVENTION

In order to solve the problems of prior art, the present invention provides a method, apparatus and system of storing, reading the directory index. The technical solutions are as follows:

according to one aspect, there provided a method of storing a directory index, characterized in that the method comprises:

all directories in the directory index are configured with identifier respectively;

according to each directory identifier, the directory index is split so as to obtain the directory split item corresponding to each directory identifier;

each directory split item and its corresponding directory identifier are stored as a record item;

Wherein each directory split item comprises at least corresponding sub-directory identifier and corresponding file storage address.

According to further aspect, there provide a apparatus for storing directory index, characterized in that said apparatus comprises:

configuration module for configuring all directories in the directory index with identifier respectively;

split module for splitting the directory index according to each directory identifier configured by the configuration module so as to obtain the directory split item corresponding to each directory identifier;

storage module for storing each directory split item obtained by the splitting module and its corresponding directory identifier as a record item;

Wherein each directory split item contains at least the corresponding sub-directory identifier and the corresponding file storage address.

According to further aspect, there provides a method for reading a directory index, characterized in that the method comprises:

receiving directory index reading request carried with the directory identifier to be read;

finding the record item containing the directory identifier to be read in the apparatus for storing the directory index, and returning the directory split item in the found record item as read results;

Wherein the directory split item is obtained by the apparatus for storing the directory index, splitting the directory index according to the identifier configured for all directories in the directory index and is stored by the apparatus for storing the directory index; the record item comprises at least the directory split item and its corresponding directory identifier.

According to further aspect, there provides a apparatus for reading the directory index, characterized in that said apparatus comprises:

receiving module for receiving directory index reading request carried with the directory identifier to be read;

find module for finding the record item containing the directory identifier to be read in the apparatus for storing the directory index, and

returning module for returning the directory split item in the found record item as read results;

Wherein the directory split item is obtained by the apparatus for storing the directory index, splitting the directory index according to the identifier configured for all directories in the directory index and is stored by the apparatus for storing the directory index; the record item comprises at least the directory split item and its corresponding directory identifier.

According to further aspect, there provides a system for reading the directory index, characterized by comprising a terminal, a apparatus for reading the directory index and a apparatus for storing the directory index;

the terminal for sending a directory index reading request carried with the directory identifier to be read to the apparatus for reading the directory index;

the apparatus for reading the directory index for receiving the directory index reading request carried with the directory identifier to be read, sent by the terminal; The apparatus for storing the directory index for configuring all directories in the directory index with identifier respectively; splitting the directory index according to each directory identifier so as to obtain the directory split item corresponding to each directory identifier; storing each directory split item and its corresponding directory identifier as a record item; wherein, each directory split item at least comprises the corresponding sub-directory identifier and corresponding file storage address.

Embodiment of the present invention provides technical solutions to bring beneficial effects:

by all directories in the directory index are configured with identifier respectively; according to each directory identifier, the directory index is split so as to obtain the directory split item corresponding to each directory identifier; each directory split item and its corresponding directory identifier are stored as a record item, refines the granularity of the directory index, thus improving access performance for the directory index.

### DESCRIPTION OF THE DRAWINGS

In order to more clearly illustrate the technical solution of the embodiments of the present invention, the following describes the used Figures in the embodiments simply. Apparently, the drawings described below are merely some embodiments of the present invention, for the skilled person in the art, in the premise without creative efforts, you can also obtain other drawings based on these drawings.

FIG. 1 is a first embodiment of the present invention, providing a flowchart of a method for storing directory index;

FIG. 2 is a second embodiment of the present invention, providing a structure diagram of a directory index system;

FIG. 3 is a second embodiment of the present invention, providing a flowchart of a method for storing directory index;

FIG. 4 is a second embodiment of the present invention, providing a diagram of directory index structure that is not split;

FIG. 5 is a second embodiment of the present invention, providing a diagram of directory index structure that has been split;

FIG. 6 is a second embodiment of the present invention, providing a process schematic of querying directory Index;

FIG. 7 is a second embodiment of the present invention, providing a process schematic to modify the name of the directory index;

FIG. 8 is a third embodiment of the present invention, providing a flowchart of a method of reading the directory index;

FIG. 9 is a fourth embodiment of the present invention, providing a first structure diagram of the apparatus for storing the directory index;

FIG. 10 is a fourth embodiment of the present invention, providing a second structure diagram of the apparatus for storing the directory index;

FIG. 11 is a fourth embodiment of the present invention, providing a third structure diagram of the apparatus for storing the directory index;

FIG. 12 is a fourth embodiment of the present invention providing a fourth structure diagram of the apparatus for storing the directory index;

FIG. 13 is a fourth embodiment of the present invention, providing a fifth structure diagram of the apparatus for storing the directory index;

FIG. 14 is a fourth embodiment of the present invention, providing a sixth structure diagram of the apparatus for storing the directory index;

FIG. 15 is a fifth embodiment of the present invention, providing a structure diagram of the system for reading the directory index; and

FIG. 16 is a sixth embodiment of the present invention, providing a structure diagram of the system for reading the directory index.

### DETAILED DESCRIPTION

In order to make the object of the present invention, technical solutions and advantages more clearly, below with reference to the drawings, the embodiments of the invention is described in further details.

### Example One

The embodiment provides a method of storing the directory index, see FIG. 1, the present embodiment provides a method process includes:

Step 101: all directories in directory index are configured with identifier;

Step 102: according to various directories identifier, directory index is split to obtain directory split item corresponding to each directory identifier; wherein each directory split item contains at least corresponding subdirectories identifier and the corresponding documents memory address;

Step 103: each directory split item and its corresponding directory identifier is stored as a record item.

Further, the present embodiment provides a method, further comprising:

receive directory index query request carried with the directory identifier to be queried;

find the record item that contains the directory identifier to be queried and return the directory split item in the found record item as query results.

Further, the present embodiment provides a method, further comprising:

receive directory modification request, the directory modification request carries with the directory identifier to be modified and the modified directory information;

find record item that contains the identifier to be modified and modify the directory split item in the found record item in accordance with the modified directory information.

Further, each directory split item and its corresponding directory identifier is stored as a record item, including but not limited to:

each directory split item and its corresponding directory identifier is stored as a record item in the corresponding storage node respectively;

the correspondence relationship between directory identifier corresponding to each directory split item and the storage node is set and stored.

Further, after the correspondence relationship between directory identifier corresponding to each directory split item and the storage node is set and stored, further comprising:

receive directory index query request carried with the directory identifier to be queried;

find storage node corresponding to the directory identifier to be queried, according to the correspondence relationship between directory identifier corresponding to each directory split item and the storage node, and return the directory split item in the record item stored in the found storage node as query results.

Further, after the correspondence relationship between directory identifier corresponding to each directory split item and the storage node is set and stored, further comprising:

receive directory modification request, the directory modification request carries the identifier to be modified and the modified directory information;

find storage node corresponding to the directory identifier to be queried, according to the correspondence relationship between directory identifier corresponding to each directory split item and the storage node, and modify the directory split item in the record item stored in the found storage node according to the modified directory information.

This embodiment provides a method comprising: all directories in the directory index are configured with identifier and the directory index is split according to each identifier, after getting the directory split item corresponding to each directory identifier, each directory split item and its corresponding directory identifier are stored as a record item, thereby refining the granularity of the directory index, thus improving access performance for directory index. In addition, by storing each of the recording item in its corresponding storage nodes, it can effectively reduce access consuming-time for directory index and save resources.

### Example Two

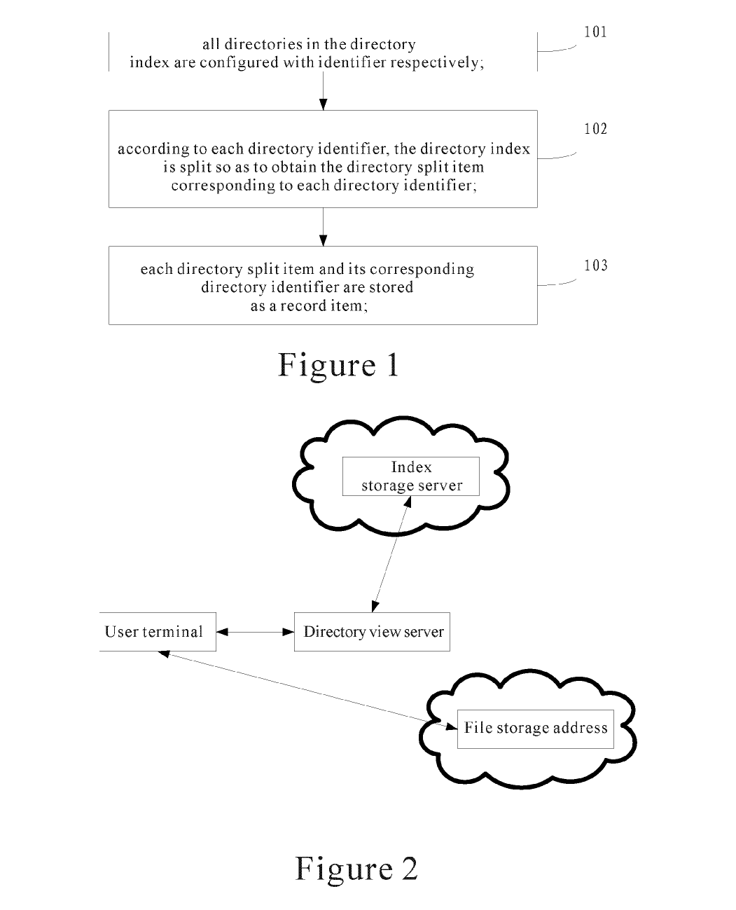

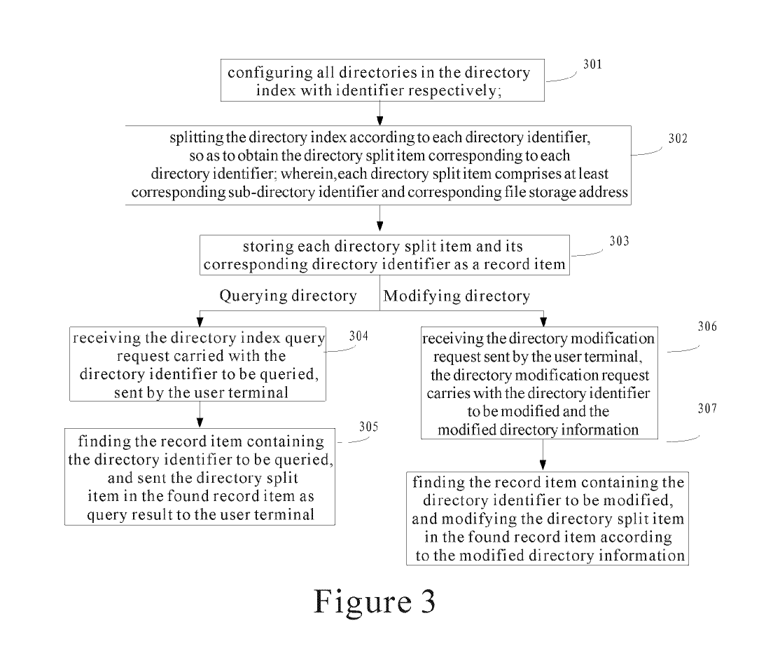

Embodiment of the invention provides a method for storing directory index, which stores the directory index and the actual file data separately. As shown in FIG. 2, after the index storage server stores directory index, the users can, by the user terminal, sends to the directory view server the access request for directory index, to perform the relevant Index access operations. After the directory view server receives a directory index access request from the user terminal, the server reads directory index corresponding to the directory index access request in the index storage servers and returns the directory index to the user terminal, so that the user terminal accesses to the file storage server the actual file data corresponding to the directory index, according to the directory index. To facilitate understanding, combining with the above content shown in FIG. 2 and the content in the first embodiment, the present embodiment makes detailed explanation to the storage directory indexes manner. Referring to FIG. 3, this embodiment provides a method process including:

Step 301: all directories in the directory index are configured with identifier;

As for this step, the embodiment will abstract each directory as an object, and each object is configured with a globally unique identifier. As for the manner of configuring the globally unique identifier, the present embodiment does not particularly limit it, and every directory corresponding to different identifiers can be. Furthermore, after all directories in the directory index are configured with identifier, the method provided in this embodiment express, by the form of the Key-Value (key-value), the information corresponding to the directory, that is, expresses the information of each directory in the directory index in the key-value form, wherein, the value of “Key” indicates the identifier of each directory, “Value” indicates the directory item in the directory.

Step 302: According to each directory identifier, the directory index is split to obtain a index split item corresponding to each directory identifier; wherein each directory split item contains at least corresponding subdirectory identifier and corresponding file storage address;

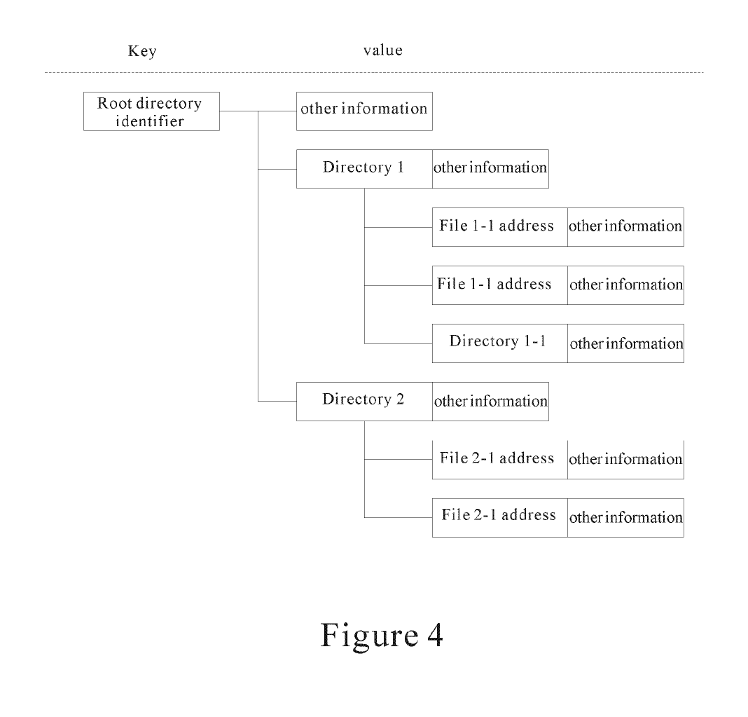

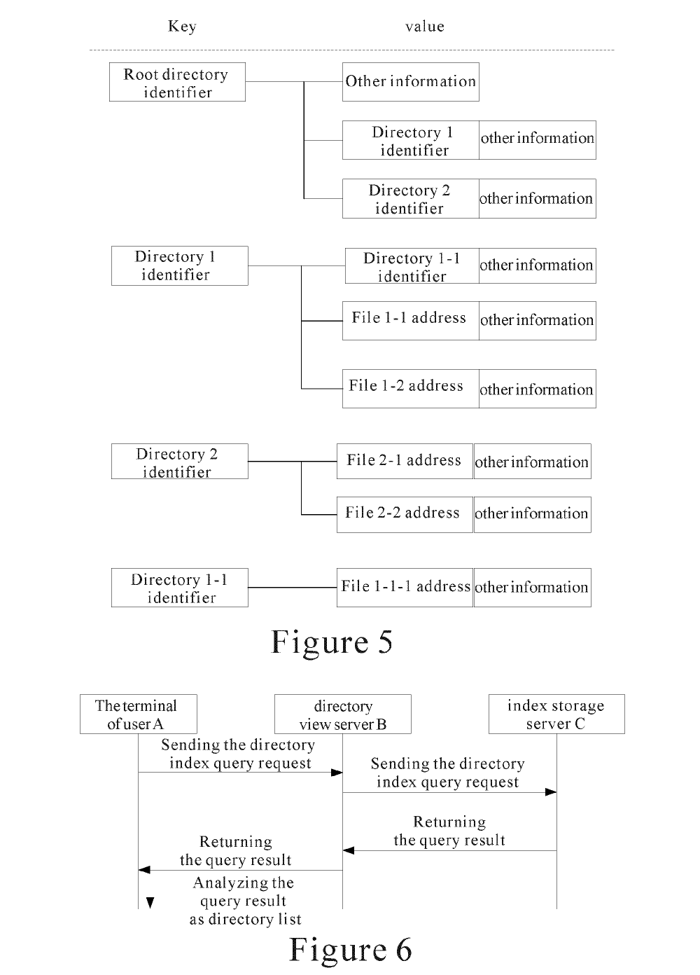

Specifically, in order for convenience of description, the present embodiment take the index structure in which the directory index I is not split as shown in FIG. 4 as an example, in which there exits two subdirectories, which are identified as directory 1 and directory 2, then after, by the above step 301, root directory of the directory index I is configured with a identifier named as I0, the directory I is configured with a identifier named as I1 and the directory I2 is configured as a identifier named as I2, the directory index I is split according to the identifiers I0, I1 and I2, obtaining the directory split item corresponding respectively to the identifiers I0, I1 and I2, the index structure of the split directory index I being shown in FIG. 5. As for the concrete implementation of splitting the directory index I, it comprises but not limit to: pull out the index information corresponding to the identifiers I0, I1 and I2, respectively, and form three directory items corresponding respectively to identifiers I0, I1 and I2.

Wherein in addition to containing the corresponding sub-directory identifier and the corresponding file storage address, each directory split item further comprises other information, such as the name of each subdirectory corresponding to each directory split item, creation time and modification time of each sub-directory, the file name of each file corresponding to the each directory split item, creation time and modification time of each file, the size of storage space occupied by each file, etc., in this embodiment, the content contained in each directory split item is not particularly limited. Of course, in addition to the above split manner, other split manner can also be used, the present embodiment does not specifically limit.

Step 303: each directory split item and its corresponding directory identifier are stored as a record item;

Specifically, each directory split item and its corresponding directory identifier are stored as a record item, including but not limited to:

each directory split item and its corresponding directory identifier are stored respectively in the corresponding storage node as a record item;

setting the correspondence relationship of the directory identifier corresponding to each directory split item and the storage node, and storing the correspondence relationship.

For example, taking the split directory index I shown in FIG. 5 as an example, after the directory split items corresponding respectively to the identifiers I0, I1 and I2, the identifiers I0, I1, I2 and their corresponding directory split items are stored in the form of record item, that is, the identifier I0 and the its corresponding directory split item being a record item named as record item T0; the identifier I1 and its corresponding directory split item being a record item named as record item T2; the identifier I2 and its corresponding directory split item being a record item named as T3; after three record item T1, T2 and T3 are obtained, the three record items are stored in corresponding storage node S. After the three record items T1, T2 and T3 are stored in the corresponding storage node S, in order to facilitate the user to quickly and easily obtains the contents of three record items, the present embodiment provides a method further comprising: providing correspondence relationship between the identifiers i0, I1 and I2 corresponding to the directory split items in the three records terms T1, T2, and T3 and the storage node S, and storing the correspondence relationship.

Wherein the correspondence relationship between the directory identifier corresponding to each directory split item and the storage node is shown in Table I below:

TABLE 1

| identifier | Storage node |
|---|---|
| I0 | S |
| I1 | S |
| I2 | S |

On storing the correspondence relationship, the storage medium may be read-only registers specifically. Of course, the type of storage media, in addition to the above read-only register, can be other types of storage media such as flash memory or hard disk, etc. The type of storage media in this embodiment is not be specifically limited.

Further, after the directory index is split and each directory split item and its corresponding directory identifier are stored respectively in the corresponding storage node as a record item through the above-mentioned step 301 to step 303, the user can, according to the identifier of each directory split item, perform some common access operations, such as query directory operations, detailed process can be found in the following step 304 to step 305; modify directory operations, detailed process can be found in the following step 306 to step 307.

Step 304: receiving a directory index query request carried with the directory identifier to be queried, sent from the user terminal;

For this step, after receiving a directory index query request carried with the directory identifier to be queried, sent from the user terminal, the directory index query request is stored in the storage medium. Wherein the storage medium is in particular the read-only registers and, of course, the type of storage media, in addition to the above read-only register, can also be other types of storage media such as flash memory or hard disk, etc., the type of storage media in this embodiment is not specifically defined.

wherein, in addition to the directory identifier to be queried, the directory index query request may also carry other information, such as the directory creation time to be queried. In the embodiment, information carried by the directory index query request is not particularly limited.

Step 305: Find the record item containing the directory identifier to be queried and send the directory split item in the found record item to the user terminal as query result.

For this step, if each directory split item and its corresponding directory identifier as a record item are stored in the corresponding storage node, after receiving a directory index query request carried with the directory identifier to be queried, sent from the user terminal, the method provided in this embodiment further comprises:

according to the correspondence relationship between the directory identifier corresponding to each directory split item and the storage node, find the storage node corresponding to the directory identifier to be queried and send the directory split item in the record item stored in the found storage node to the user terminal as query result.

For example, take FIG. 6 as an example to make detailed explanation to the above process. Assume that a user wants to query the directory split item corresponding to the identifier I1 in the directory index shown in FIG. 5, the terminal of the user A generates the directory index query request according to the identifier I1, and then sends the directory index query request to the index storage server C through the directory view server B, the index storage server C, after receiving the directory index query request, query the correspondence relationship of the identifier and the storage node stored in the storage medium in advance according to the directory index query request, and obtain the storage node information storing the directory to be query. After that, the directory split item in the record item stored in the found storage node as query result is sent to the terminal of the user A through the directory view server B.

It should be noted that the query directory operation ends. Further, the present embodiment provides a method to support the operation of modifying the directory and the specific process is described in the step 306 to step 307.

Step 306: receiving a directory modification request sent from the user terminal, the directory modification request is carried with the identifier of the directory to be modified and the modified directory information.

For this step, after receiving a directory modification request sent from the user terminal, the directory index query request is stored in the storage medium. Wherein, the storage medium is in particular the read-only registers and, of course, the type of storage media, in addition to the above read-only register, can be other types of storage media such as flash memory or hard disk, etc., the type of storage media in this embodiment is not specifically defined.

Among them, the directory modification request, in addition to carrying the identifier of the directory to be modified and the modified directory information, further carry other information, for example, the creation time of the directory to be modified, in the embodiment, the information carried by the directory modification request is not particularly limited.

Step 307: Find the record item containing the directory identifier to be modified, and modify the directory split item in the found record item according to the modified directory information.

For this step, if each directory split item and its corresponding directory identifier as a record item are stored in the corresponding storage node, after receiving a directory modification request sent from the user terminal, the method provided in this embodiment further comprises:

according to the correspondence relationship between the directory identifier corresponding to each directory split item and the storage node, find the storage node corresponding to the directory identifier to be queried and modify the directory split item in the record item stored in the found storage node according to the modified directory information.

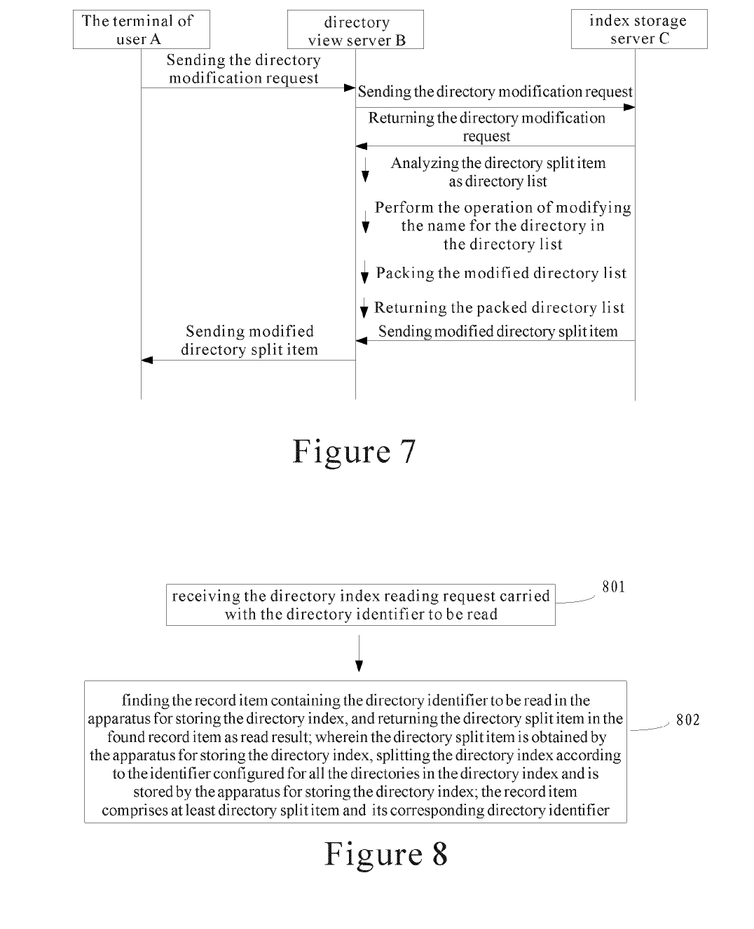

For example, take FIG. 7 as an example to make detailed explanation to the above process. Assume that a user wants to modify the directory name corresponding to the identifier I1 in the directory index shown in FIG. 5, the terminal of the user A generates the directory modification request according to the parent directory identifier I0 of the identifier I1, and then sends the directory modification request to the index storage server C through the directory view server B, the index storage server C, after receiving the directory modification request, query the correspondence relationship of the identifier I0 and the storage node stored in the storage medium in advance according to the identifier I0 carried by the directory modification request and obtain the storage node information storing the directory to be query. After that, the directory split item in the record item stored in the found storage node is sent to the directory view server B. Directory view server B, receiving the directory split item returned by the index storage server C, split the directory split item for analysis, to get a directory list, and modify the name of the directory 1 in the directory list according to the modified directory information modification directory list carried by the directory modification request. After the modification, new directory list is sent in package to the index storage server C. Finally, the index storage server C sends the modified directory to the terminal of the user A through the directory view server B.

This embodiment provides a method comprising: all directories in the directory index are configured with identifier and the directory index is split according to each directory identifier, after getting the directory split item corresponding to each directory identifier, each directory split item and its corresponding directory identifier are stored as a record item, thereby refining the granularity of the directory index, thus improving access performance for directory index. In addition, by storing each recording item in its corresponding storage nodes, it can effectively reduce access consuming-time for directory index and save resources.

### Example Three

The embodiment provides a method to reading the directory index, seeing FIG. 8, the present embodiment provides a method process including:

Step 801: Receiving a directory index reading request carried with the directory identifier to be read;

For this step, after receiving the directory index reading request carried with the directory identifier to be read, the directory index reading request is stored in the storage medium. Wherein the storage medium is in particular the read-only registers and, of course, the type of storage media, in addition to the above read-only register, can also be other types of storage media such as flash memory or hard disk, etc., the type of storage media in this embodiment is not defined.

Wherein directory index reading request, in addition to carrying the identifier of the directory to be read, can also carry additional information such as the creation time of the directory to be read, in this embodiment, the information carried by the directory index reading request is not particularly limited.

Step 802: find the record item containing the directory identifier to be read in the apparatus storing the directory index and return the directory split item in the found record item as reading result; wherein the directory split item is obtained by the apparatus storing the directory index, to split the directory index according to the identifier configured for all the directories in the directory index and is stored by the apparatus storing the directory index; the recording item comprises at least the directory split item and its corresponding directory identifier.

For this step, find the record item containing the directory identifier to be read, comprising:

Determining the storage node storing the record item containing the directory identifier to be read according to the correspondent relationship between the directory identifier corresponding to each directory split item and the storage node;

Finding the record item containing the directory identifier to be read from the determined storage node;

Wherein, the correspondence relationship between the directory identifier corresponding to each directory item and the storage node is set and stored by the apparatus storing the directory index.

For example, a user wants to read the directory split item corresponding to a directory identifier of the apparatus storing the directory index, the user terminal after generating the directory index reading request according to the directory identifier, sends the directory index reading request to the apparatus reading the directory index, the apparatus for reading the directory index, after receiving the directory index reading request, query the correspondence relationship between the directory identifier and the storage node stored in advance in the storage medium of the apparatus for storing the directory the directory index, according to the directory identifier carried by the directory index reading request, and obtain the storage node information storing the record item containing the directory identifier. After that, the directory split item in the record item stored in the found storage node as reading result is returned to the user terminal and displayed to the user by the user terminal Wherein, the manner of the apparatus for storing the directory index storing the directory index see the description for the embodiment two, and is omitted herein.

In the method provided by this embodiment, since the apparatus for storing the directory index split the directory index and obtain the directory split item, according to the identifier configured for the all the directory in the directory index, and store them, this method receives the directory index reading request carried with the directory identifier to be read, and find the record item containing the directory identifier to be read, in the apparatus for storing the directory index, and return the directory split item in the found record item as reading result without returning all directory index, thus the access performance of the directory index can be improved greatly.

### Example Four

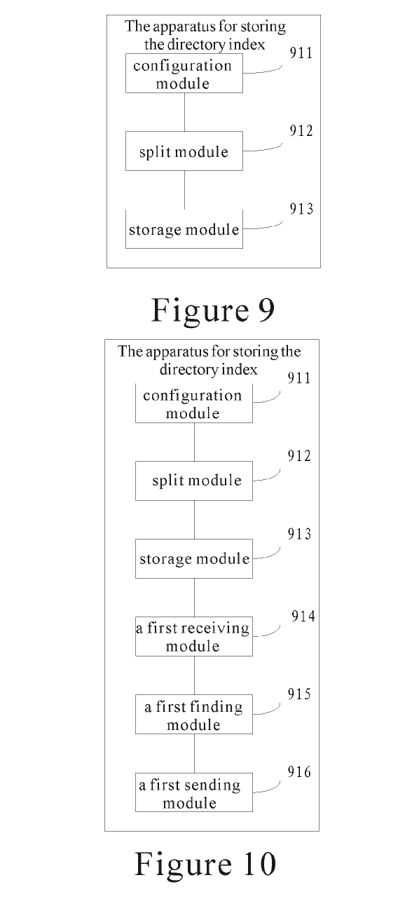

Embodiment of the invention provides a apparatus for storing directory index for performing the method provided by the above embodiment 1 and embodiment 2, seeing FIG. 9, the apparatus comprising:

Configuration module 911 for configuring identifier for all the directory in the directory index;

Split module 912 for splitting the directory index according to each directory identifier configured by the configuration module 911 to obtain a directory split item corresponding to each directory identifier;

Storage module 913 for storing each directory split item obtained by the split module and its corresponding directory identifier as a record item;

Wherein, each directory split item comprises at least corresponding sub-directory identifier and corresponding file storage address.

Further, seeing FIG. 10, the apparatus further comprising:

a first receiving module 914 for receiving the directory index query request carried with the directory identifier to be queried, sent from the user terminal'

a first finding module 915 for finding the recording item containing the directory identifier received by the first receiving module 914;

a first sending module 916 for sending the directory split item in the record item found by the first finding module 915 as query result to the user terminal

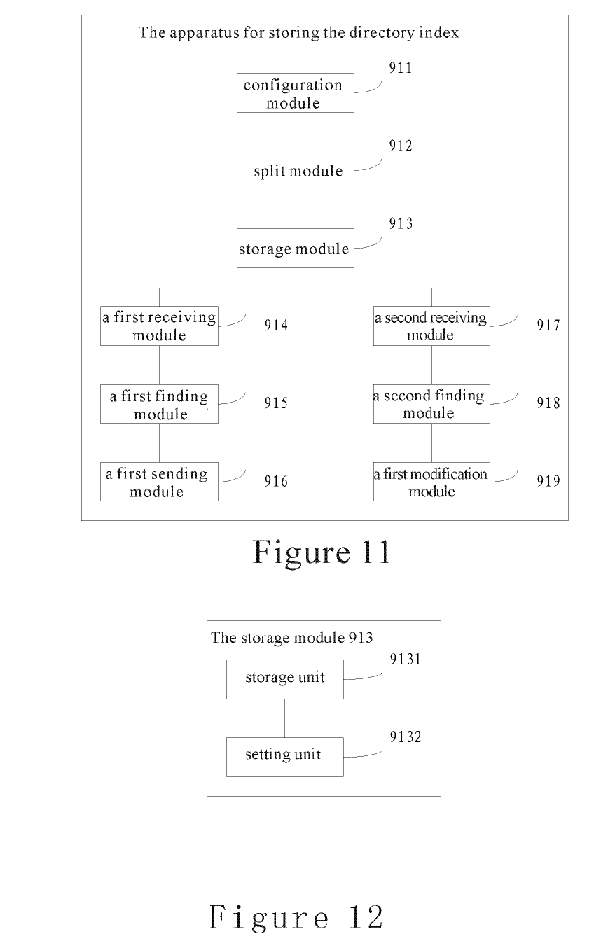

Further, seeing FIG. 11, the apparatus further comprising:

a second receiving module 917 for receiving the directory modification request sent by the user terminal, the directory modification request is carried with the directory identifier to be modified and the modified directory information;

a second finding module 918 for finding the record item containing the directory identifier to be modified received by the second receiving module 917;

a first modification module 919 for modifying the directory split item in the record item found by the second finding module 918 according to the modified directory information.

Further, seeing FIG. 12, the storage module 913 comprising:

a storage unit 9131 for storing each directory split item and its corresponding directory identifier as a record item in the corresponding storage node respectively;

a setting unit 9132 for setting the correspondent relationship between the directory identifier corresponding to the each directory split item and the storage node and storing the correspondence relationship.

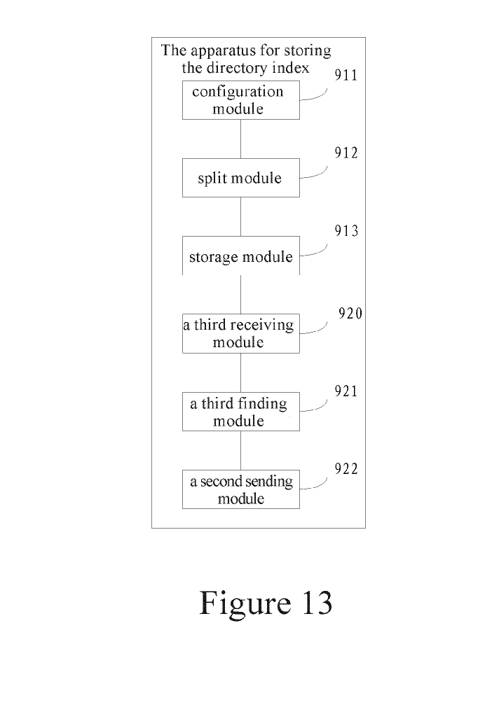

Further, seeing FIG. 13, the apparatus further comprising

a third receiving module 920 for receiving the directory index query request carried with the directory identifier to be queried, sent from the user terminal;

a third find module 921 for finding the storage node corresponding to the directory identifier to be queried, received by the third receiving module 920 according to the correspondence relationship between the directory identifier corresponding to each directory split item and the storage node;

a second sending module 922 for sending the directory split item in the recording item stored in the storage node found in the third finding module 921 as query result to the user terminal;

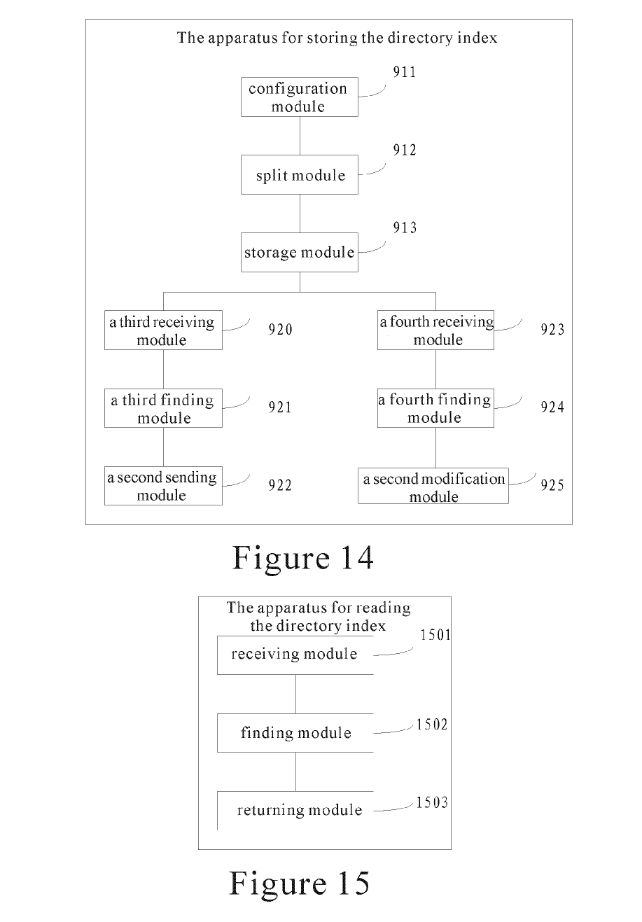

Further, seeing FIG. 14, the apparatus further comprises:

a fourth receiving module 923 for receiving the directory modification request sent from the user terminal, the directory modification request is carried with the directory identifier to be modified and the modified directory information;

a fourth finding module 924 for finding the storage node corresponding to the directory identifier to be queried received by the fourth receiving module 923 according to the correspondence relationship between the directory identifier corresponding to each directory split item and the storage node;

a second modification module 925 for modifying the directory split item in the record items stored in the storage node found by the fourth finding module 924 according to the modified directory information.

This embodiment provides a apparatus, comprising: all directories in the directory index are configured with identifier and the directory index is split according to each directory identifier, after getting the directory split item corresponding to each directory identifier, each directory split item and its corresponding directory identifier are stored as a record item, thereby refining the granularity of the directory index, thus improving access performance for directory index. In addition, by storing each recording item in its corresponding storage nodes, it can effectively reduce access consuming-time for directory index and save resources.

### Example Five

The embodiment of the invention provides a apparatus for reading the directory index for performing the method provided by the above embodiment three, seeing FIG. 15, the apparatus comprising:

receiving module 1501 for receiving the directory index reading request carried with the directory identifier to be read;

finding module 1502 for finding the record item containing the directory identifier to be read, received by the receiving module 1501;

returning module 1503 for returning the directory split item in the record item found by the finding module 1502 as reading result;

Wherein the directory split item is obtained by the apparatus for storing the directory index splitting the directory index according the identifier configured for all the directories in the directory index and is stored by the apparatus for storing the directory index; the record index comprises at least the directory split item and its corresponding directory identifier.

Further, the finding module 1502 for determining the storage node storing the record item containing the directory identifier to be read according to the correspondence relationship between the directory identifier corresponding to each directory split item and the storage node; finding the record item containing the directory identifier to be read from the determined storage node;

Wherein, the correspondence relationship between the directory identifier corresponding to each directory split item and the storage node is set and stored by the apparatus for storing the directory index.

In the apparatus provided by this embodiment, since the apparatus for storing the directory index split the directory index and obtain the directory split item, according to the identifier configured for the all the directory in the directory index, and store them, this apparatus receives the directory index reading request carried with the directory identifier to be read, and find the record item containing the directory identifier to be read, in the apparatus for storing the directory index, and return the directory split item in the found record item as reading result without returning all directory index, thus the access performance of the directory index can be improved greatly.

### Example Six

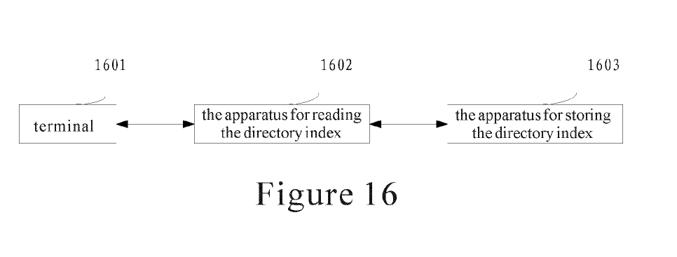

Embodiment of the invention provides a system for reading the directory index, seeing FIG. 16, the system comprising: the terminal 1601, the apparatus 1602 for reading the directory index and the apparatus 1603 for storing the directory index;

The terminal 1601 for sending the directory index reading request carried with the directory identifier to be read to the apparatus for reading the directory index;

The apparatus 1602 for reading the directory index for receiving the directory index reading request carried with the directory identifier to be read sent from the terminal 1601; finding the record item containing the directory identifier to be read in the apparatus for storing the directory index, and returning the directory split item in the found record item as reading result;

The apparatus 1603 for storing the directory index, for configuring all the directory in the directory index; splitting the directory index according to each directory identifier to obtain the directory split item corresponding to each directory identifier; storing each directory split item and its corresponding directory identifier as a record item; wherein each directory split item comprises at least the corresponding sub-directory identifier and corresponding file storage address.

Further, when the apparatus 1603 for storing the directory index stores each directory split item and its corresponding directory identifier as a record item, it stores each directory split item and its corresponding directory identifier as a record item in the corresponding storage node respectively; setting the correspondence relationship between the directory identifier corresponding to each directory split item and the storage node and storing the correspondence relationship;

When the apparatus 1602 for reading the directory index finds the record item containing the directory identifier to be read, it determines the storage node storing the record item containing the directory identifier to be read according to the correspondence relationship between the directory identifier corresponding to each directory split item and the storage node; finding the record item containing the directory identifier to be read from the determined storage node;

In the system provided by this embodiment, since the apparatus for storing the directory index split the directory index and obtain the directory split item, according to the identifier configured for the all the directory in the directory index, and store them, this system receives the directory index reading request carried with the directory identifier to be read, and find the record item containing the directory identifier to be read, in the apparatus for storing the directory index, and return the directory split item in the found record item as reading result without returning all directory index, thus the access performance of the directory index can be improved greatly.

It should be noted that: when the apparatus for storing the directory index stores the directory index, when the apparatus and the system for reading the directory index reads the directory index, the above is explained in the functional module division. In actual practice, the above can be performed by the different functional modules according to the need, that is, dividing the inner structure of the apparatus and the system into different functional modules so as to perform all or part of the above-described functions. In addition, the apparatus for storing the directory index and the method for storing the directory index belong to the same idea and the apparatus and the system for reading the directory index and the method for reading the directory index belong to the same idea and its specific implementation process see embodiment of the method, not repeat them here.

The embodiment number of the present invention is only for the description and does not represent the good or bad of embodiments.

Ordinary skill in the art can understand all or part of the steps in the above embodiments can be done by hardware, or by a program instructing relevant hardware, the program may be stored in a computer-readable storage medium, the said storage medium may be read-only memory, magnetic or optical disk.

The foregoing is only preferred embodiments of the present invention and is not intended to limit the invention, where the present invention is within the spirit and principle, any modification, equivalent replacement, improvement, etc., should be included in the present invention, the protective range.

What is claimed is:

1. A method of storing a directory index, characterized in that the method comprises:
all directories in the directory index are configured with identifier respectively;
according to each directory identifier, the directory index is split so as to obtain the directory split item corresponding to each directory identifier;
each directory split item and its corresponding directory identifier are stored as a record item;
wherein each directory split item comprises at least corresponding sub-directory identifier and corresponding file storage address.

2. The method according to claim 1, characterized in that further comprising:
receiving the directory index query request carried with the directory identifier to be queried;
finding the record item containing the directory identifier to be queried and returning the directory split item in the found record item as query result.

3. The method according to claim 1, characterized in that further comprising:
receiving directory modification request, the directory modification request carries the identifier to be modified and the modified directory information;
finding the recording item containing the identifier to be modified and modifying the directory split item in the found record item in accordance with the modified directory information.

4. The method according to claim 1, characterized in that each directory split item and its corresponding directory identifier are stored as a record item comprising:
each directory split item and its corresponding directory identifier as a record item are stored in the corresponding storage node;
the correspondence relationship between the directory identifier corresponding to each directory split item and the storage node is set and stored.

5. The method according to claim 4, characterized in that after the correspondence relationship between the directory identifier corresponding to each directory split item and the storage node is set and stored, further comprising:
receiving the directory index query request carried with the directory identifier to be queried;
according to the correspondence relationship between the directory identifier corresponding to each directory split item and the storage node, finding the storage node corresponding to the directory identifier to be queried, and returning the directory split item in the record item stored in the found storage node as query result.

6. The method according to claim 4, characterized in that after the correspondence relationship between the directory identifier corresponding to each directory split item and the storage node is set and stored, further comprising:
receiving a directory modification request, the directory modification request carries the identifier to be modified and the modified directory information;
according to the correspondence relationship between the directory identifier corresponding to each directory split item and the storage node, finding the storage node corresponding to the directory identifier to be queried, and modify the directory split item in the record item stored in the found storage node in accordance with the modified directory information.

7. An apparatus for storing directory index, characterized in that said apparatus comprises:
configuration module for configuring all directories in the directory index with identifier respectively;
split module for splitting the directory index according to each directory identifier configured by the configuration module so as to obtain the directory split item corresponding to each directory identifier;
storage module for storing each directory split item obtained by the splitting module and its corresponding directory identifier as a record item;
wherein each directory split item contains at least the corresponding sub-directory identifier and the corresponding file storage address.

8. The apparatus according to claim 7, characterized in that said apparatus further comprises:
a first receiving module for receiving a directory index query request carried with the directory identifier to be queried;
a first finding module for finding the record item containing the directory identifier to be queried, received by the first receiving module;
a first sending module for returning the directory split item in the record item found by the first finding module as query result.

9. The apparatus according to claim 7, characterized in that said apparatus further comprises:
a second receiving module for receiving a directory modification request, the directory modification request carries the directory identifier to be modified and the modified directory information;
a second finding module for finding the record item containing the directory identifier to be modified, received by the second receiving module;
a first modification module for modifying the directory split item in the record item found by the second finding module in accordance with the modified directory information.

10. The apparatus according to claim 7, characterized in that the storage module comprises:
a storage unit for storing each directory split item and its corresponding identifier as a record item in the corresponding storage node respectively;
a setting unit for setting and storing correspondence relationship between the directory identifier corresponding to each directory split item and the storage node.

11. The apparatus according to claim 10, characterized in that said apparatus further comprises:
a third receiving module for receiving a directory index query request carried with the directory identifier to be queried;
a third finding module for according to the correspondence relationship between the directory identifier corresponding to each directory split item and the storage node, finding the storage node corresponding to the directory identifier to be queried, received by the third receiving module;
a second sending module for returning the directory split item in the record item stored in the storage node found by the third finding module as query result.

12. The apparatus according to claim 10, characterized in that said apparatus further comprises:
a fourth receiving module for receiving a directory modification request, the directory modification request carries the directory identifier to be modified and the modified directory information;
a fourth finding module for according to the correspondence relationship between the directory identifier corresponding to each directory split item and the storage node, finding the storage node corresponding to the directory identifier to be queried, received by the fourth receiving module;
a second modification module for modifying the directory split item in the record item found by the fourth finding module in accordance with the modified directory information.

13. A method for reading a directory index, characterized in that the method comprises:
receiving directory index reading request carried with the directory identifier to be read;
finding the record item containing the directory identifier to be read in the apparatus for storing the directory index, and returning the directory split item in the found record item as read results;
wherein the directory split item is obtained by the apparatus for storing the directory index, splitting the directory index according to the identifier configured for all directories in the directory index and is stored by the apparatus for storing the directory index; the record item comprises at least the directory split item and its corresponding directory identifier.

14. The method according to claim 13, characterized in that, finding the record item containing the directory identifier to be read comprising:
determining the storage node storing the record item containing the directory identifier to be read according to the correspondence relationship between the directory identifier corresponding to each directory split item and the storage node;
finding the record item containing the directory identifier to be read from the determined storage node;
wherein the correspondence relationship between the directory identifier corresponding to each directory split item and the storage node is set and stored by the apparatus for storing the directory index.

15. A apparatus for reading the directory index, characterized in that said apparatus comprises:
receiving module for receiving directory index reading request carried with the directory identifier to be read;
find module for finding the record item containing the directory identifier to be read in the apparatus for storing the directory index, and
returning module for returning the directory split item in the found record item as read results;
wherein the directory split item is obtained by the apparatus for storing the directory index, splitting the directory index according to the identifier configured for all directories in the directory index and is stored by the apparatus for storing the directory index; the record item comprises at least the directory split item and its corresponding directory identifier.

16. The apparatus according to claim 15, characterized in that the finding module further
determining the storage node storing the record item containing the directory identifier to be read according to the correspondence relationship between the directory identifier corresponding to each directory split item and the storage node; finding the record item containing the directory identifier to be read from the determined storage node;
wherein the correspondence relationship between the directory identifier corresponding to each directory split item and the storage node is set and stored by the apparatus for storing the directory index.

17. A system for reading the directory index, characterized by comprising a terminal, a apparatus for reading the directory index and a apparatus for storing the directory index;
the terminal for sending a directory index reading request carried with the directory identifier to be read to the apparatus for reading the directory index;
the apparatus for reading the directory index for receiving the directory index reading request carried with the directory identifier to be read, sent by the terminal;
the apparatus for storing the directory index for configuring all directories in the directory index with identifier respectively; splitting the directory index according to each directory identifier so as to obtain the directory split item corresponding to each directory identifier; storing each directory split item and its corresponding directory identifier as a record item; wherein, each directory split item at least comprises the corresponding sub-directory identifier and corresponding file storage address.

18. The system according to claim 17, characterizing in that the apparatus for storing the directory index, when storing each directory split item and its corresponding directory identifier, stores each directory split item and its corresponding directory identifier in corresponding storage node respectively; setting and storing the correspondence relationship between the directory identifier corresponding to each directory split item and the storage node;
the apparatus for reading the directory index, when finding the record item containing the directory identifier to be read, determines the storage node storing the record item containing the directory identifier to be read according to the correspondence relationship between the directory identifier corresponding to each directory split item and the storage node; finds the record item containing the directory identifier to be read from the determined storage node.
